(19) United States
(12) Patent Application Publication
(10) Pub. No.: US 2011/0002734 A1
(43) Pub. Date: Jan. 6, 2011

(54) Swiveling locking mechanism of a telescopic rod of a mop

(76) Inventors: Yung-Hua Chen, Lujhou City (TW); Chin-Yang Shin, Gueishan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,119

(22) Filed: Jul. 1, 2009

(51) Int. Cl. F16B 2/02

(52) U.S. Cl. 403/350

(57) ABSTRACT

A swiveling locking mechanism of a telescopic rod of a mop, including: an internal clamping sleeve, an external clamping cylinder, and a U-shaped locking arm. The upper portion of the internal clamping sleeve is constructed as an internal tube for the insertion and the fixing of the bottom of the external rod in place, and the lower portion of thereof is formed as a conic body with an indentation. The external clamping cylinder is mounted on the internal clamping sleeve and provided with two mounting holes corresponding to the positioning holes of the internal tube, and the lower portion thereof is constructed as a trumpet-shaped opening mounted on the conic body. The U-shaped locking arm includes a swivel protrusion and an eccentric cam at the internal wall of both sides thereof for fitting into the positioning holes of the internal clamping sleeve and the mounting holes of the external clamping cylinder, and the eccentric cams are positioned within the mounting holes. In this way, when the U-shaped locking arm swivels on the swivel protrusion, the eccentric cams are offset within the mounting holes such that the external clamping cylinder can be moved upward and downward relative to the external rim of the internal clamping sleeve, and the trumpet-shaped opening of the external clamping cylinder can be brought due to the action of the indentation in a tightened or a loosened position relative to the conic body of the internal clamping sleeve such that the internal and external rods are locked in place or unlocked in a telescopic state.

### BACKGROUND OF THE INVENTION

1. Field of the Invention

The invention relates to a swiveling locking mechanism of a telescopic rod of a mop, and more particularly to a structure in which an internal sleeve is clamped or unclamped by an external swivel action such that the telescopic rod is brought in a locked or unlocked state.

2. Description of the Related Art

It is laborious when people wash floors in a kneeling position. Therefore, a mop with a handle is developed. The user can stand and easily hold the handle to move the mop for washing the floor.

The handle made specifically to be grasped or held by the hand of the operator may consist of an external rod and an internal rod for making the handle in a telescopic state by means that the internal rod is driven by the external rod. The telescopic function is beneficial for the transportation or for storage with less space. However, a locking mechanism is required at the attachment position of the external rod internal rods for locking them in place or unlocking them in a telescopic state.

However, a drive assembly is required within the handle when the telescopic handle is not only extendable or retractable, but also a driving relationship is employed. Therefore, the conventional locking mechanism is not suitable for this kind of the telescopic handle. It has to be modified for meeting the requirement of a convenient operation. Otherwise, the conventional mechanism may cause an improper operation, thereby leading to damage and lowering the service life.

### SUMMARY OF THE INVENTION

An object of the invention is to provide a swiveling locking mechanism of a telescopic rod of a mop that has an ergonomic operation structure for providing the operator with a practical and convenient use.

Another object of the invention is to provide a swiveling locking mechanism of a telescopic rod of a mop that avoids an improper operation so that the defective rate can be reduced for prolonging the service life.

In order to achieve the above-mentioned objects, a swiveling locking mechanism of a telescopic rod of a mop in accordance with the invention includes:

a) an internal rod;

b) an external rod having a bottom portion in a telescopic connection with a top portion of the internal rod;

c) a disc attached to the bottom of the internal rod and having a plurality of mop yarns; and

d) a locking mechanism mounted on the external rod for locking the internal rod and the external rod in place or for unlocking them in a telescopic state, the locking mechanism including an internal clamping sleeve, an external clamping cylinder, and a U-shaped locking arm,

wherein the upper portion of the internal clamping sleeve is constructed as an internal tube for the insertion and the fixing of the bottom of the external rod in place, and a positioning hole is formed in both sides of the internal clamping sleeve, and the lower portion of the internal clamping sleeve is formed as a conic body expanding from top to bottom, and the conic body includes an indentation;

wherein the external clamping cylinder is mounted on the internal clamping sleeve, and the upper portion of the external clamping cylinder is constructed as an external tube corresponding to the internal tube, and both sides of the external tube are provided with two mounting holes corresponding to the positioning holes of the internal tube, and the lower portion of the external clamping cylinder is constructed as a trumpet-shaped opening mounted from top to bottom on the conic body; and

wherein the U-shaped locking arm includes a swivel protrusion and an eccentric cam at the internal wall of both sides thereof for fitting into the positioning holes of the internal clamping sleeve and the mounting holes of the external clamping cylinder, and the eccentric cams are positioned within the mounting holes,

whereby, when the U-shaped locking arm swivels on the swivel protrusion, the eccentric cams are offset within the mounting holes such that the external clamping cylinder can be moved upward and downward relative to the external rim of the internal clamping sleeve, and the trumpet-shaped opening of the external clamping cylinder can be brought due to the action of the indentation in a tightened or a loosened position relative to the conic body of the internal clamping sleeve such that the internal and external rods are locked in place or unlocked in a telescopic state.

### BRIEF DESCRIPTION OF THE DRAWINGS

The accomplishment of this and other objects of the invention will become apparent from the following descriptions and its accompanying figures of which:

FIG. 1 is a perspective view of a preferred embodiment of the invention;

FIG. 2 is an exploded perspective view of the main structure of the invention;

FIG. 3 is a cross-sectional view taken along the line 3-3 in FIG. 4;

FIG. 4 is a schematic drawing of the invention seen in direction of the line 4-4 in FIG. 3;

FIG. 5 is a schematic drawing of the invention in a loosened position when the external clamping cylinder is moved upward;

FIG. 6 is a schematic drawing of the invention in a tightened position when the external clamping cylinder is moved downward; and

FIG. 7 is a schematic drawing of an application state of the invention.

### DETAILED DESCRIPTION OF THE PREFERRED EMBODIMENT

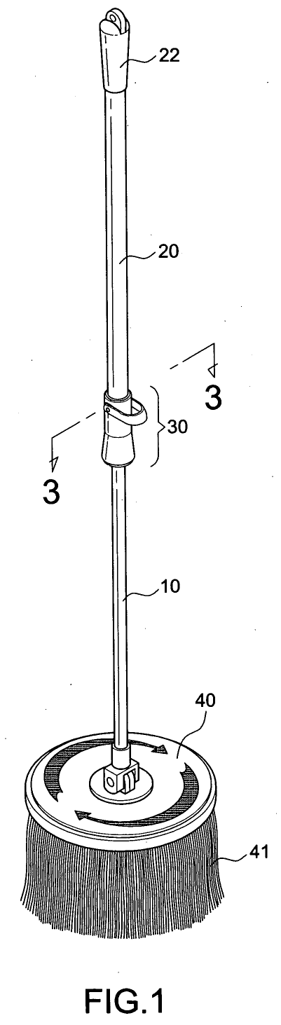

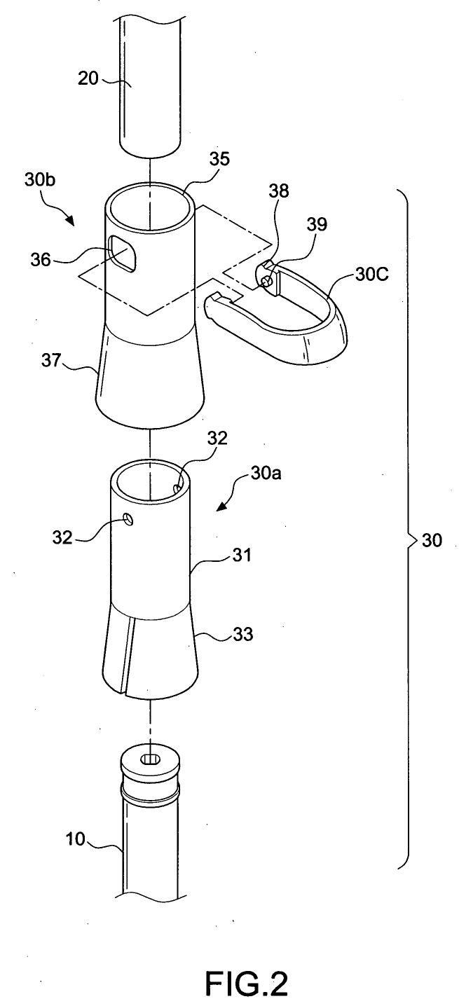

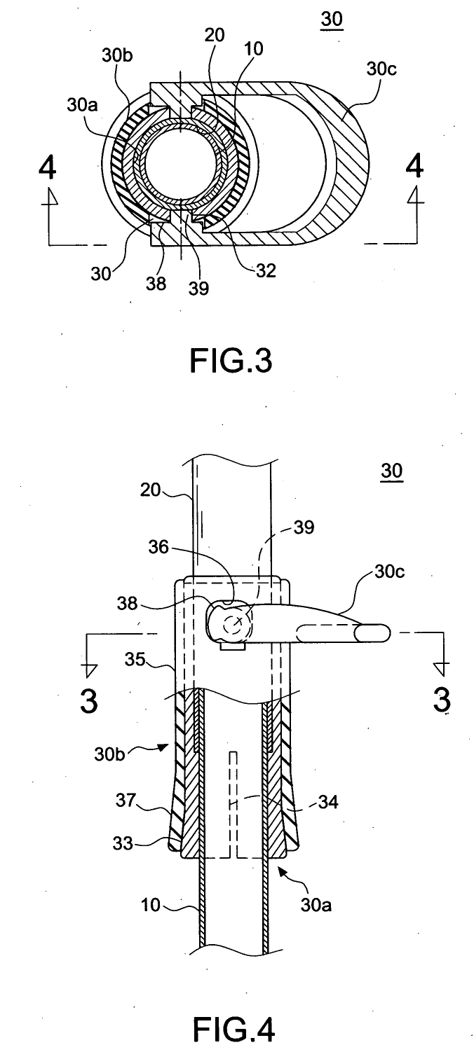

First of all, referring to FIGS. 1 through 7, a preferred embodiment of the invention includes an internal rod 10, an external rod 20, a disc, and a locking mechanism 30. The external rod 20 includes a bottom portion in a telescopic connection with a top portion of the internal rod 10. The disc is attached to the bottom of the internal rod 10 and includes a plurality of mop yarns 41. The locking mechanism 30 is mounted on the external rod 20 for locking the internal rod 10 and the external rod 20 in place or for unlocking them in a telescopic state.

According to the features of the invention, the locking mechanism 30 includes an internal clamping sleeve 30a, an external clamping cylinder 30b, and a U-shaped locking arm 30c. The upper portion of the internal clamping sleeve 30a is constructed as an internal tube 31 for the insertion and the fixing of the bottom of the external rod 20 in place. The fixing can be done in a clamping, locking, hooking or screwing way. These fixing ways belong to the prior art so that no further descriptions thereto are given hereinafter. A positioning hole 32 is formed in both sides of the internal clamping sleeve 30a. The lower portion of the internal clamping sleeve 30a is formed as a conic body 33 expanding from top to bottom. The conic body 33 includes an indentation 34 extending in axial direction. It is preferable to have more than two indentations 34.

The external clamping cylinder 30b is mounted on the internal clamping sleeve 30a. The upper portion of the external clamping cylinder 30b is constructed as an external tube 35 corresponding to the internal tube 31. Both sides of the external tube 35 are provided with two mounting holes 36 corresponding to the positioning holes 32 of the internal tube 31. According to the embodiment, the mounting holes 36 are non-circular and constructed as rectangular holes. However, the form thereof should not be restricted thereto. Moreover, the center of the mounting holes 36 is not aligned to the center of the positioning hole 32 such that eccentric cams 38 within the mounting holes 36 fulfill the eccentric pushing function. The lower portion of the external clamping cylinder 30b is constructed as a trumpet-shaped opening 37 mounted from top to bottom on the conic body 33.

The U-shaped locking arm 30c includes a swivel protrusion 39 and an eccentric cam 38 at the internal wall of both sides thereof for fitting into the positioning holes 32 of the internal clamping sleeve 30a and the mounting holes 36 of the external clamping cylinder 30b. Besides, the eccentric cams 38 are positioned within the mounting holes 36. According to this embodiment, the swivel protrusions 39 together with the eccentric cams 38 and the U-shaped locking arm 30c are formed by the injection-molding process. However, it should not be restricted thereto. In other words, the swivel protrusion 39 can be replaced by a processed metal post.

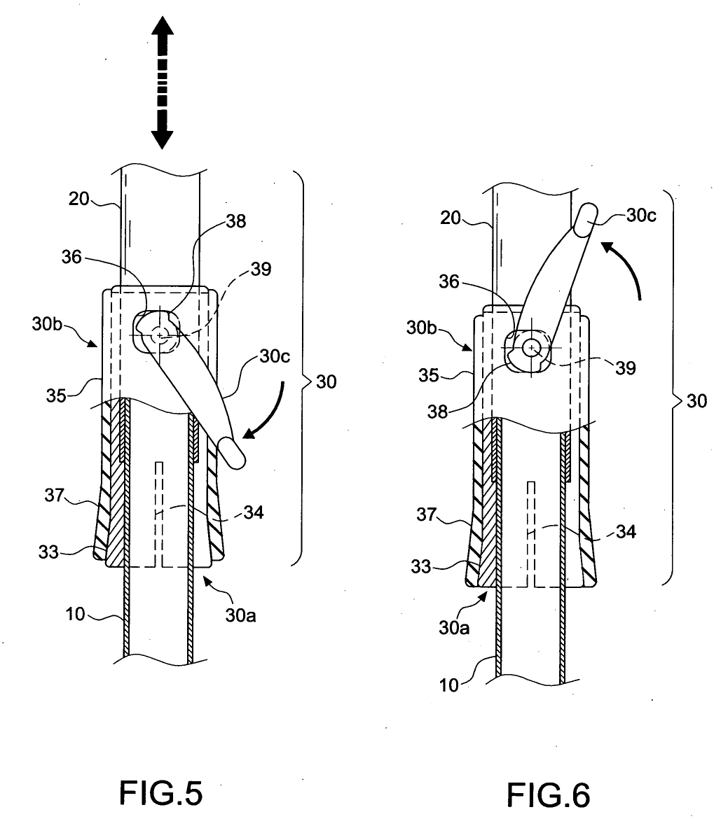

Based upon the above-mentioned structure, the eccentric cams 38 are offset within the mounting holes 36 when the U-shaped locking arm 30c swivels on the swivel protrusion 39. In this way, the external clamping cylinder 30b can be moved as desired. As shown in FIG. 5, the external rim of the internal clamping sleeve 30a rises when the U-shaped locking arm 30c is pushed downward. Due to the action of the indentation 34, the trumpet-shaped opening 37 of the external clamping cylinder 30b is brought in a loosened position relative to the conic body 33 of the internal clamping sleeve 30a. As a result, the internal rod 10 and the external rod 20 are unlocked and brought in a telescopic state. As shown in FIG. 6, the external rim of the internal clamping sleeve 30a is moved downward when the U-shaped locking arm 30c is pulled upward. In this way, the internal clamping sleeve 30a is so clamped that the internal and external rods 10, 20 are fixed in place.

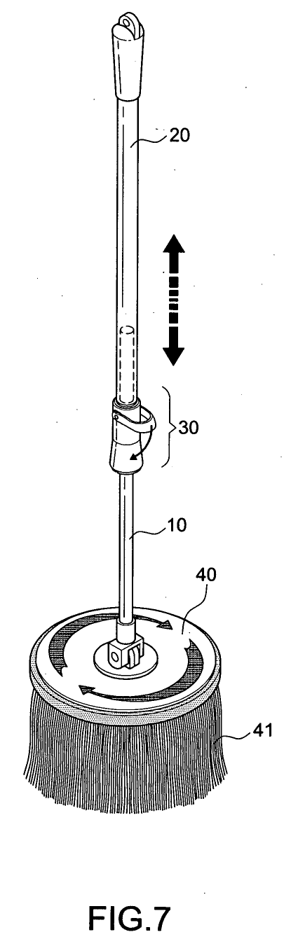

As shown in FIG. 7, the locking mechanism 30 in accordance with the invention has an ergonomic operation structure that provides the operator with a practical and convenient use.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A swiveling locking mechanism of a telescopic rod of a mop, comprising:
a) an internal rod;
b) an external rod having a bottom portion in a telescopic connection with a top portion of the internal rod;
c) a disc attached to the bottom of the internal rod and having a plurality of mop yarns; and
d) a locking mechanism mounted on the external rod for locking the internal rod and the external rod in place or for unlocking them in a telescopic state, the locking mechanism including an internal clamping sleeve, an external clamping cylinder, and a U-shaped locking arm,
wherein the upper portion of the internal clamping sleeve is constructed as an internal tube for the insertion and the fixing of the bottom of the external rod in place, and a positioning hole is formed in both sides of the internal clamping sleeve, and the lower portion of the internal clamping sleeve is formed as a conic body expanding from top to bottom, and the conic body includes an indentation;
wherein the external clamping cylinder is mounted on the internal clamping sleeve, and the upper portion of the external clamping cylinder is constructed as an external tube corresponding to the internal tube, and both sides of the external tube are provided with two mounting holes corresponding to the positioning holes of the internal tube, and the lower portion of the external clamping cylinder is constructed as a trumpet-shaped opening mounted from top to bottom on the conic body; and
wherein the U-shaped locking arm includes a swivel protrusion and an eccentric cam at the internal wall of both sides thereof for fitting into the positioning holes of the internal clamping sleeve and the mounting holes of the external clamping cylinder, and the eccentric cams are positioned within the mounting holes,
whereby, when the U-shaped locking arm swivels on the swivel protrusion, the eccentric cams are offset within the mounting holes such that the external clamping cylinder can be moved upward and downward relative to the external rim of the internal clamping sleeve, and the trumpet-shaped opening of the external clamping cylinder can be brought due to the action of the indentation in a tightened or a loosened position relative to the conic body of the internal clamping sleeve such that the internal and external rods are locked in place or unlocked in a telescopic state.

2. The swiveling locking mechanism of a telescopic rod of a mop as recited in claim 1 wherein the internal tube of the internal clamping sleeve is secured to the external rod in a clamping, locking, hooking or screwing way.

3. The swiveling locking mechanism of a telescopic rod of a mop as recited in claim 1 wherein the mounting holes of the external clamping cylinder are non-circular.
